(19) United States
(12) Patent Application Publication
(10) Pub. No.: US 2002/0128420 A1
(43) Pub. Date: Sep. 12, 2002

(54) Polyurethane elastomers and method of manufacture thereof

(76) Inventors: Scott S. Simpson, Woodstock, CT (US); Sujatha Narayan, Putnam, CT (US); Michael Lunt, Abington, CT (US)

Correspondence Address: CANTOR COLBURN, LLP, 55 GRIFFIN ROAD SOUTH, BLOOMFIELD, CT, 06002

(21) Appl. No.: 10/033,542

(22) Filed: Dec. 26, 2001

Related U.S. Application Data
(60) Provisional application No. 60/258,401, filed on Dec. 27, 2000.

(51) Int. Cl. C08G 18/00

(52) U.S. Cl. 528/44

(57) ABSTRACT

A thermoformable polyurethane elastomer having excellent compression set resistance, and a thermoformable polyurethane elastomer having excellent compression set resistance and shape retention under load. In another embodiment, at least one additional layer of a polyurethane elastomer is integrally bonded to the thermoformable elastomer. A moisture management system for polyurethane elastomers is also described. The elastomers have particular utility as shoe sole inserts.

### CROSS REFERENCE TO RELATED APPLICATIONS

This application claims the benefits of U.S. Provisional Patent Application Serial No. 60/258,401, filed Dec. 27, 2000, which is incorporated herein by reference in its entirety.

### BACKGROUND OF THE INVENTION

1. Field of the Invention

This invention relates generally to polyurethane elastomers. More particularly, this invention relates in one embodiment to polyurethane elastomers that are thermoformable at elevated temperatures, and have good low temperature and/or room temperature compression set resistance. In another embodiment, this invention relates to thermoformable polyurethane elastomers having moisture management properties. Such thermoformable and moisture managing elastomers may be used in single or dual layer constructions.

2. Description of the Related Art

Thermoplastic materials are useful in forming lightweight, thin, strong sheets that are formable into complex shapes without any rippling or buckling of the material. Such sheets have a wide variety of different uses, for example as insoles, arch supports, door edges and seals, and in safety gear. To obtain a desired shape, the thermoplastic material may be cast, poured, or injected into a mold under heat and pressure. The material adapts to the configuration of the casting sheet or mold. Suitable thermoplastic materials for forming into complex shapes include acrylics, polypropylenes, and polyethylenes. Despite numerous advantages, thermoplastic materials may not be as durable or resistant to breaking as would sometimes be desirable.

U.S. Pat. No. 4,778,717 discloses a composite thermoplastic material that can be easily formed, and even reformed if necessary, at elevated temperatures to any desired complex shape with relatively minimal buckling or rippling. The composite is formed from a core material of a thermoplastic resin and two layers of fabric material, each disposed on the opposite sides of the core. The layers of fabric have a total thickness sufficient to impart strength and rigidity to the composite, while the core is of a sufficient thickness to provide for a shaping of the composite thermoplastic material at an elevated temperature to any desired shape or configuration. While useful for its intended purposes, manufacture of this composite requires multiple materials and steps.

Conventional hydrophilic or moisture managing polyurethane foams are known, and are typically formulated from a hydrophilic polyurethane formulation and large amounts of water as a blowing agent. Typically these foams have very poor physical properties and compression set resistance, which renders them ineffective as cushioning materials. In contrast, polyurethane foams, for example the PORON® foams manufactured by Rogers Corporation with very high compression set resistance and excellent cushioning properties typically exhibit low water absorption.

Hydrophilic, flexible polyurethane foams that retain a compressed form are disclosed in U.S. Pat. No. 6,034,149. The foam is made of water reacted with a prepolymer. The prepolymer is made by reacting excess polyisocyanate with a polyether polyol, the polyol having an average nominal hydroxyl functionality of 2 to 6. These hydrophilic foams are used as diapers, sponges, and wound dressings. Composite materials for absorbing and dissipating body fluids and moisture are disclosed in U.S. Pat. No. 5,763,335. The foam layer is established by combining an aqueous mixture including the sorbent in a pre-determined ratio with the hydrophilic polyurethane. U.S. Pat. No. 5,763,335 teaches generally hydrophilic foam, but does not teach how to attain a moisture-managing foam that has good compression set resistance and comfort properties.

Polyurethane elastomers having a combination of thermoformability at elevated temperatures and excellent compression set resistance at room and/or low temperatures, especially together with good shape retention under load or elevated temperature, have not yet been achieved. Similarly, thermoformable elastomers that are also moisture managing and have excellent cushioning and compression set resistance, have not yet been achieved. Moisture management is defined herein as the ability of the elastomer to absorb water (greater than or equal to 50% of its own weight when immersed in water as per ASTM D570) in conjunction with the ability to give up the absorbed water or dry to less than or equal to 20% of the absorbed water in less than or equal to 24 hours. There is accordingly a present need for a polyurethane elastomer that is thermoformable with or without moisture managing characteristics and has good compression set resistance and shape retention properties.

### SUMMARY OF THE INVENTION

The above-described and other deficiencies found in the art are overcome or alleviated by a thermoformable polyurethane elastomer with excellent low temperature compression set resistance, formed from a composition comprising an isocyanate having a mole average functionality less than or equal to 2.15, an active hydrogen-containing component having a mole average active hydrogen functionality less than or equal to 2.14, and a catalyst.

In another embodiment, a thermoformable polyurethane elastomer with excellent low temperature compression set resistance and shape retention under load or elevated temperature is formed from a composition comprising an isocyanate having amole average functionality less than or equal to 2.15, an active hydrogen-containing component having a mole average active hydrogen functionality greater than or equal to 2.065, and less than or equal to 2.14, and a catalyst.

In these embodiments, the molecular weight of the active hydrogen-containing component is preferably selected so as to enhance phase separation of hard and soft segments. The low functionality of the isocyanate results in a elastomer having little or no cross linking in the hard segment phase, which in turn leads to the formation of defined hard domains that allow the material to be “melted” or to “flow” at elevated temperatures and set as the material is cooled. The elastomer still possesses structural integrity and good compression set resistance due to the small amount of crosslinking in the soft segment. Preferred thermoforming temperatures to shape the elastomer are 110° C. to 170° C. When heated to thermoforming temperatures, shaped and then cooled, the strength, or modulus, of the hard segment phase forces the soft segment phase to take and retain the desired shape.

Another embodiment comprises the above-described compositions and thermoformable polyurethane elastomers with a moisture management system, for example poly(N-vinyl acrylamide) and/or sodium carboxy methylcellulose powder, to increase the water absorption and render the elastomer moisture managing. Moisture management in these embodiments is surprisingly obtained without use of hydrophilic polyurethanes.

Another embodiment comprises the above-described thermoformable polyurethane elastomers and a second polyurethane elastomer layer integrally bonded thereto. The second layer may be, for example, a slow recovery polyurethane elastomer or a resilient polyurethane elastomer, and may optionally be a moisture managing elastomer.

### BRIEF DESCRIPTION OF THE DRAWINGS

Referring now to the drawings, wherein like elements are numbered alike,

FIG. 1 is a schematic drawing of the apparatus and test conducted to measure thermoformability;

FIG. 2 is a schematic drawing of the apparatus and test conducted to measure the shape retention of the foam or elastomer after it has been subjected to load; and

### DESCRIPTION OF THE PREFERRED EMBODIMENTS

A thermoformable polyurethane elastomer with excellent compression set resistance is formed from a composition comprising an organic isocyanate component having an average isocyanate (or hard segment) functionality of less than or equal to 2.15, preferably less than or equal to or equal to 2.10, most preferably less than or equal to 2.05. Preferably, the average functionality is greater than or equal to 1.80, preferably greater or equal to 2.00. The composition further comprises an active hydrogen-containing component having an average functionality of less than or equal to 2.14; and a catalyst. Elastomers having both thermoformability and excellent shape retention under load and/or elevated temperature may be obtained by limiting the average functionality of the active hydrogen-containing component to greater than or equal to 2.065.

The low functionality of the isocyanate component provides elastomer having little or no cross-linking in the hard segment phase of the cured elastomer. This leads to phase separated hard domains that can soften or melt, while the small amount of cross linking in the active hydrogen-containing component results in excellent room temperature compression set resistance and allows the material to maintain structural integrity even when the hard domains deform. Without the cross linking in the soft segment phase, the compression set resistance is poor. Too much crosslinking results in loss of thermoformability. The amount of soft segment phase cross linking is adjusted to obtain the desired thermoformability at a certain elevated temperature while maintaining good room temperature and low temperature compression set resistance and shape retention characteristics. In this way, the desired balance of thermoformability and shape retention characteristics can be adjusted for different application requirements.

The organic isocyanate components preferably are those having the general formula:

Q(NCO)ᵢ

wherein i corresponds to the hard segment functionality described above, and Q is an organic radical having the valence of i. Q can be a substituted or unsubstituted hydrocarbon group (i.e., an alkylene or an arylene group). Q can be a group having the formula Q¹-Z-Q¹ wherein Q¹ is an alkylene or arylene group and Z is —O—, —O—Q¹—, —C(O)—, —S—, —S(O)—, —S(O)—Q¹—S—, —S—Q¹—S—, or —SO₂—. Examples of such compounds include hexamethylene diisocyanate, 1,8-diisocyanato-p-methane, xylyl diisocyanate, diisocyanatocyclohexane, phenylene diisocyanates, tolylene diisocyanates, including 2,4-tolylene diisocyanate, 2,6-tolylene diisocyanate, and crude tolylene diisocyanate, bis (4-isocyanatophenyl) methane, chlorophenylene diisocyanates, diphenylmethane-4,4′-diisocyanate (also known as 4,4′-diphenyl methane diisocyanate, or MDI), naphthalene-1,5-diisocyanate, triphenylmethane 4,4,4″-triisocyanate, and mixtures of such isocyanates.

Q can also represent a polyurethane radical having a valence of i in which case Q(NCO)ᵢ is a composition conventionally known as a prepolymer. Such prepolymers are formed by reacting a stoichiometric excess of a polyisocyanate as set forth hereinbefore and hereinafter with an active hydrogen-containing component as set forth hereinafter, especially the polyhydroxyl-containing materials or polyols described below. Usually, for example, the polyisocyanate is employed in proportions of 30 percent to 200 percent stoichiometric excess, the stoichiometry being based upon equivalents of isocyanate group per equivalent of hydroxyl in the polyol. A preferred prepolymer type of isocyanate for the current invention is Mondur PF, which is a urethane modified prepolymer sold by Bayer Corporation.

Further included among useful polyisocyanates are dimers and trimers of isocyanates and diisocyanates and polymeric diisocyanates such as those having the general formula:

[Q²(NCO)ᵢ]ⱼ

in which i is an integer of one or more,j is an integer of two or more, and Q² is a polyfunctional organic radical. An example is polymethylene polyphenyl isocyanate. Q² may also be a compound of the general formula:

L(NCO)ᵢ

in which i is one or more and L is a monofunctional or polyfunctional atom or radical. Examples of this type include ethylphosphonic diisocyanate, C₂H₅P(O)(NCO)₂, phenylphosphonic diisocyanate, C₆H₅P(O)(NCO)₂, compounds containing a trivalent siliconcyanate group, isocyanates derived from sulfonamides (QSO₂NCO), cyanic acid, and thiocyanic acid.. Combinations of all of the foregoing may also be used. In general, the aromatic polyisocyanates are preferred because of their greater reactivity.

Of course, a blend of any of the foregoing isocyanate may be used, as long as the total mole average isocyanate functionality is within the specified range. A preferred isocyanate is pure 4,4′ MDI or a modified pure MDI. The amount of polyisocyanate employed will vary slightly depending upon the nature of the polyurethane being prepared. In general, the total —NCO equivalent to total active hydrogen equivalent should be such as to provide a ratio of 0.8 to 1.1 equivalents of—NCO per equivalent of active hydrogen, e.g., hydroxyl hydrogen, of the active hydrogen reactant, and preferably a ratio of 1.0 to 1.04 equivalents of—NCO per active hydrogen.

The active hydrogen-containing component generally includes a mixture of polyhydroxyl-containing compounds, such as hydroxyl-terminated polyhydrocarbons (U.S. Pat. No. 2,877,212); hydroxyl-terminated polyformals (U.S. Pat. No. 2,870,097); fatty acid triglycerides (U.S. Pat. Nos. 2,833,730 and 2,878,601); hydroxyl-terminated polyesters (U.S. Pat. Nos. 2,698,838, 2,921,915, 2,591,884, 2,866,762, 2,850,476, 2,602,783, 2,729,618, 2,779,689, 2,811,493, and 2,621,166); hydroxymethyl-terminated perfluoromethylenes (U.S. Pat. Nos. 2,911,390 and 2,902,473); polyalkylene ether glycols (U.S. Pat. No. 2,808,391; British Pat. No. 733,624); polyalkylene ether glycols (U.S. Pat. No. 2,808,391; British Pat. No. 733,624); polyalkylenearylene ether glycols (U.S. Pat. No. 2,808,391); and polyalkylene ether triols (U.S. Pat. No. 2,866,774).

Especially preferred polyhydroxyl-containing materials are the polyether polyols obtained by the chemical addition of alkylene oxides, such as ethylene oxide, propylene oxide and mixtures thereof, to water or polyhydric organic compounds, such as ethylene glycol, propylene glycol, trimethylene glycol, 1,2-butylene glycol, 1,3-butanediol, 1,4-butanediol, 1,5-pentanediol, 1,2-hexylene glycol, 1,10-decanediol, 1,2-cyclohexanediol, 2-butene-1,4-diol, 3-cyclohexene-1,1-dimethanol, 4-methyl-3-cyclohexene-1,1-dimethanol, 3-methylene-1,5-pentanediol, diethylene glycol, (2-hydroxyethoxy)-1-propanol, 4-(2-hydroxyethoxy)-1-butanol, 5-(2-hydroxypropoxy)-1-pentanol, 1-(2-hydroxymethoxy)-2-hexanol, 1-(2-hydroxypropoxy)-2-octanol, 3-allyloxy-1,5-pentanediol, 2-allyloxymethyl-2-methyl-1,3-propanediol, [4,4-pentyloxy)-methyl]-1,3-propanediol, 3-(o-propenylphenoxy)-1,2-propanediol, 2,2′-diisopropylidenebis(p-phenyleneoxy)diethanol, glycerol, 1,2,6-hexanetriol, 1,1,1-trimethylolethane, 1,1,1-trimethylolpropane, 3-(2-hydroxyethoxy)-1,2-propanediol, 3-(2-hydroxypropoxy)-1,2-propanediol, 2,4-dimethyl-2-(2-hydroxyethoxy)-methylpentanediol-1,5, 1,1,1-tris[2-hydroxyethoxy) methyl]-ethane, 1,1,1-tris[2-hydroxypropoxy)-methyl] propane, diethylene glycol, dipropylene glycol, pentaerythritol, sorbitol, sucrose, lactose, alpha-methylglucoside, alpha-hydroxyalkylglucoside, novolac resins, and the like. The alkylene oxides employed in producing polyoxyalkylene polyols normally have 2 to 4 carbon atoms. Propylene oxide and mixtures or propylene oxide with ethylene oxide are preferred. The polyols listed above can be used per se as the active hydrogen compound.

A preferred class of polyether polyols is represented generally by the following formula

R[(OCHₙH₂ₙ)_{z}OH]ₐ

wherein R is hydrogen or a polyvalent hydrocarbon radical; a is an integer (i.e., 1 or 2 to 6 to 8) equal to the valence of R, n in each occurrence is an integer of 2 to 4 inclusive (preferably 3) and z in each occurrence is an integer having a value of 2 to 200, preferably of 15 to 100.

Preferred polyhydroxyl-containing materials are the polyester polyols, which comprise aromatic polyester polyols based on phthalic anhydride, polymers of cyclic esters, and aliphatic polyester polyols based on diethylene glycol and adipic acid. Especially preferred polyhydroxyl-containing materials are the aromatic polyester polyols and caprolactone based polyester polyols. It has been unexpectedly discovered that the polyester polyol, in addition to the polyether polyol, produces enhanced phase separation and formation of distinct hard domains. Other polyols or additives that enhance phase separation, e.g., polybutadiene polyols may be used.

The preferred amount of phase separating polyol or additive is typically less than or equal to 50% by weight of polyol component, preferably less than or equal to 40%, and most preferably less than or equal to 30%.

In one preferred embodiment, the polyol component comprises one or a mixture of a low molecular weight diol, including but not being limited to dipropylene glycol and 2-methyl-1,3 propanediol; one polypropylene oxide triol having a molecular weight of 2000 to 4000; one or a mixture of a aromatic phthalic anhydride-based polyester diol having a molecular weight in the range of 400 to 600.

The polyol or polyol mixture can have hydroxyl numbers that vary over a wide range. In general, the hydroxyl numbers of the polyols or mixtures thereof, including other cross-linking additives, if employed, can be from 28 to 1000, and higher, preferably 50 to 800. The hydroxyl number is defined as the number of milligrams of potassium hydroxide required for the complete neutralization of the hydrolysis product of the fully acetylated derivative prepared from 1 gram of polyol or mixtures of polyols with or without other cross-linking additives used in the invention. The hydroxyl number can also be defined by the equation:

$$OH = \frac{56.1 \times 1000 \times f}{M . W}$$

wherein OH is the hydroxyl number of the polyol, f is the average functionality, that is average number of hydroxyl groups per molecule of polyol, and M.W. is the average molecular weight of the polyol.

The exact polyol or polyols employed depends upon the desired degree of thermoformability and compression set resistance. Variation in the polyol component can also yield a wide range of moduli and toughness. The total polyol mixture and any additives therein preferably possess a total average hydroxyl number of 75 to 200 or more when employed in flexible elastomer formulations. Typical total average hydroxyl numbers used in these examples is 155 to 165. Such limits are not intended to be restrictive, but are merely illustrative of the large number of possible combinations of the polyols that can be employed.

Catalysts include various inorganic metal compounds and metal compounds that include certain organic groups. Metal acetyl acetonates are preferred, based on metals such as aluminum, barium, cadmium, calcium, cerium (III), chromium (III), cobalt (II), cobalt (III), copper (II), indium, iron (II), lanthanum, lead (II), manganese (II), manganese (III), neodymium, nickel (II), palladium (II), potassium, samarium, sodium, terbium, titanium, vanadium, yttrium, zinc and zirconium. A common catalyst is bis(2,4-pentanedionate) nickel (II) (also known as nickel acetylacetonate or diacetylacetonate nickel) and derivatives thereof such as diacetonitrilediacetylacetonato nickel, diphenylnitrilediacetylacetonato nickel, bis(triphenylphosphine)diacetyl acetylacetonato nickel, and the like. Ferric acetylacetonate is particularly preferred, due to its relative stability, good catalytic activity, and lack of toxicity. The metal acetylacetonate is most conveniently added by predissolution in a suitable solvent such as dipropylene glycol or other hydroxyl containing compound which will then participate in the reaction and become part of the final product.

Added to the metal acetyl acetonate is acetyl acetone (2,4-pentanedione), as disclosed in commonly assigned U.S. Pat. No. 5,733,945 to Simpson, which is incorporated herein by reference. It has been discovered that the acetyl acetone can be used to delay or inhibit the normally reactive metal acetyl acetonate at the lower temperatures needed to achieve proper mixing and casting. In other words, the acetyl acetone provides heat latency, which allows time for the required mixing, casting, and other procedures, and avoids deleterious premature curing during low temperature processing. However, as the material is cured in the several heating zones and the temperature of the urethane mixture rises, the acetyl acetone is driven off. With the acetyl acetone removed together with its associated delaying function, the metal acetyl acetonate is allowed to resume its normally high reactivity and provide a very high level of catalysis at the end of the polyurethane reaction. This high reactivity late in the processing cycle is advantageous and provides improved physical properties such as compression set resistance. In general, the ratio of metal acetyl acetonate to acetyl acetone is 2:1 on a weight basis. The amount of catalyst present in the liquid phase is preferably in the range of 0.03 to 3.0 weight percent based on the weight of the active hydrogen-containing compound.

Other, optional additives may be added to the polyurethane froth mixture in the manufacturing process. For example, conventionally used additives such as fillers (alumina trihydrate, silica, talc, calcium carbonate, clay, and the like), dyes, pigments (for example titanium dioxide and iron oxide) and the like can be used. Use of hindered amine light stabilizers further imparts UV resistance. Appropriate selection of anti-oxidant yields improved high temperature resistance and scorch resistance, which is useful during the thermoforming process. Some preferred antioxidants are phenolic-based such as BHT, Irganox 1135, and the like and amine-based such as Irganox 5057. Especially preferred is a combination of IRGANOX 1135 and IRGANOX 5057. Effective quantities are 0.10 to 0.30 weight percent antioxidant, preferably 0.12 to 0.20 weight percent based on the total weight of the polyol components.

The thermoformable elastomers of this invention have a thermoforming factor (TForm factor) of 0.5 or greater, and more preferably 0.7 or greater, where a Tform factor of 1.0 defines a perfectly thermoformable material. A method for determining the Tform factor is set forth below.

The most preferred elastomers additionally have a recovery factor of 0.4 or greater, and more preferably 0.5 or greater, as measured by the procedure described below. The recovery factor relates to the shape retention of a formed material after the material has been under a compressive force or an elevated temperature (50° C.) for a period of time. The pressure is removed or the material is cooled and allowed to relax before the recovery factor is measured. A recovery factor equal to the Tform factor defines a material that returns to its original thermoformed shape. Although the recovery factor is never greater than or equal to the Tform factor, the higher the recovery factor, the better the retention of the shape rendered during thermoforming.

The compression set resistance of the present elastomers is 0 to 30%, preferably less than or equal to 10% at room temperature, and 10 to 30% at 50° C. Compression set resistance is the amount, measured in percent, by which a standard test piece of elastomer fails to return to its original thickness after being subjected to a 50% compression for 22 hours at the appropriate temperature.

In another embodiment, the thermoformable elastomers are used in a multi-layer, preferably dual layer, construction comprising a thermoformable polyurethane elastomer layer and at least one second polyurethane layer, wherein the second polyurethane layer may be a soft foam or elastomer, a slow recovery foam or elastomer, a non-resilient foam or elastomer, a moisture managing foam or elastomer, or a resilient foam such as PORON®, to create a variety of performance features for such uses as footwear, sound absorption, and safety applications. As used herein “slow recovery polyurethane” means polyurethanes, particularly foams, having a time to 90% recovery of greater than or equal to 0.25 seconds after compression to 50% of its original thickness and held for 15 seconds (for example 92 grade PORON® elastomer) and/or a loss factor (RDA) of greater than or equal to 0.5 at room temperature. Slow recovery polyurethanes typically exhibit significant dependence of their modulus or stiffness on the temperature and/or especially the frequency, or velocity of impact compression. This produces excellent comfort in many applications by providing a very soft feel yet excellent energy absorption during impacts.

In contrast to slow recovery polyurethanes, resilient foams or elastomers as used herein means foams or elastomers that recover from compression more quickly. This feature results in these materials providing excellent cushioning by their resilient behavior, which returns most of the energy applied to them rather than absorbing it. Resilient polyurethanes, particularly foams, thus means polyurethanes having a time to 90% recovery of less than or equal to 0.25 seconds and /or a loss factor (RDA) of less than or equal to 0.5. Slow recovery and resilient polyurethanes are also formed from compositions comprising an organic isocyanate component reactive with an active hydrogen-containing component, and a catalyst as defined above. Methods and formulations for the formation of resilient polyurethane elastomers are disclosed, for example, in U.S. Pat. Nos. 5,973,016 and 5,922,781.

One method of manufacture of the multi-layer composite comprises casting an uncured (wet) polyurethane composition onto a cast, uncured (wet) polyurethane composition, then curing the composite compositions as described in U.S. application Ser. No. 09/892,899, file Jun. 27, 2001 by the Assignee hereof Such elastomers are integrally bonded, well adhered, and do not readily delaminate. An adhesive is not required. Another method of manufacture of the dual layer composite comprises casting an uncured (wet) polyurethane composition onto a cast, cured (dry) polyurethane composition, then curing the composite elastomer compositions as described in U.S. Pat. No. 5,859,081. Yet another method of manufacture of the dual layer elastomer comprises laminating the individual elastomer layers together generally by using adhesives. Of course, multi-layer constructions comprising more than two layers are also within the scope of the present invention.

In yet another embodiment, the thermoformable elastomer further comprises a moisture management system. Moisture management is particularly important in footwear applications for comfort. The thermoformable elastomer formulations described above absorb low amounts of water, i.e., less than or equal to 50% when tested per ASTM D570. It has been found that addition of suitable additives can provide moisture managing elastomers, wherein moisture managing is defined as exhibiting a water absorption value of greater than or equal to 50% and drying to less than or equal to 20% of water absorbed, under ambient conditions, in less than or equal to 24 hours.

Surprisingly, use of certain additives results in moisture management without the need to resort to the hydrophilic polyurethanes or large amounts of water as a blowing agent as disclosed in much of the prior art, and without significantly adversely affecting the thermoformability, shape retention, compression set resistance, and cushioning properties of the base thermofornable elastomer. In addition, such additives provide a mechanism for desorption of moisture. Unlike other water scavenging additives such as molecular sieves, the additives below allow for not only absorption of moisture, but also the desorption or drying of the moisture, which is critical in many applications. For example, in the footwear industry as it relates to the ability of an insole material to absorb, or store excess moisture from body fluids or other moisture and to release the moisture when not in use, to provide improved comfort to the wearer.

Suitable additives include sodium carboxy methylcellulose, wood powder, cornstarch, poly(N-vinyl acrylamide), potassium acrylates, sodium acrylates, calcium carbonate, and mixtures comprising at least one of the foregoing moisture management additives. A preferred additive is sodium carboxy methyl cellulose (NaCMC) available under the trade name PE29XLX-3 from S&G Resources, or Finnifix 700P or Cekol 700P from Noviant BV. The level of water absorption can be tailored with the amount of moisture managing additive used. Usually only small quantities are required to provide greater than or equal to 50% water absorption under ambient conditions in less than or equal to 24 hours, generally 1 to 20 wt %, and preferably 5 to 15 wt % of the total formulation.

The present thermoformable polyurethane elastomer provides a product superior to those found in the art by offering the advantages of thermoformability, excellent compression set resistance, shape retention, moisture management ability and flexibility. Importantly, the shape retention under load or elevated temperature and room temperature compression set resistance of the present thermoformable polyurethane elastomer provide significant advantages over prior art thermoformable elastomers. The subject elastomers are thus useful for a wide variety of applications, such as footwear insoles, inner pads for safety equipment, speaker edges, gaskets, door closure edges and seals, and medical equipment padding.

Other additives may also be used, for example bactericides and/or odor elimination additives.

All references and patents cited herein are incorporated by reference. The polyurethane foams are further described by the following non-limiting examples:

### EXAMPLES

Chemicals, sources, and descriptions are listed in Table 1 below.

TABLE 1

| Trade Name | Source | Description |
|---|---|---|
| PPG 2000/2025 | Bayer Corp | Polypropylene ether based |
| | | polyether diol, MW = 2000 |
| | | g/mole |
| PPG 425 | Bayer Corp | Polypropylene ether based |
| | | polyether diol, MW = 425 |
| | | g/mole |
| MPDiol | — | 2-methyl-1,3-propane diol (chain |
| | | extender) |
| LG 56 | Bayer Corp. | Polypropylene ether based |
| | | polyester triol, MW = 3000 |
| | | g/mole. |
| TONE 0201 | Union Carbide | Polycaprolactone-based |
| | | polyester diol, MW = 500 |
| | | g/mole. |
| Stepanpol PS2402 | Stepan Chemical | Ortho phthalate-diethylene |
| | Company | glycol based polyester polyol, |
| | | MW = 560 g/mole. |
| DPG | — | Dipropylene glycol (diol chain |
| | | extender) |
| LHT 112 | Bayer Corp | Polypropylene ether based |
| | | polyether triol, MW = 1500 |
| | | g/mole. |
| LHT 240 | Bayer Corp | Polypropylene ether based |
| | | polyether triol, MW = 2000 |
| | | g/mole. |
| CEKOL 700P | Noviant BV | Sodium carboxy methyl |
| | | cellulose |
| PE29XLX-3 | S&G Resources | Sodium carboxy methyl |
| | | cellulose |
| PNVA NA010F | Showa Denko | Poly(N-vinyl acrylamide) |
| Alumina | — | Aluminum trihydrate (flame |
| | | retardant filler) |
| Calcium Carbonate | — | Filler |
| 3A Sieve | U.O.P. | Alkali metal alumino silicate, |
| | | K₁₂[(AlO₂)₁₂(SiO₂)₁₂].XH₂O |
| | | (water absorption) |
| IRGANOX 1135 | Ciba | Hindered phenol (antioxidant) |
| IRGANOX 5057 | Ciba | Aromatic amine (antioxidant) |
| BHT | Naugard | Butylated hydroxytoluene |
| | | (antioxidant) |
| Catalyst | — | 0.25 wt % Ferric acetyl |
| | | acetonate and 0.75 wt % acetyl |
| | | acetone in polyol |
| Baytuft 751 | Bayer | Polymeric diphenyl methane |
| | | diisocyanate, % NCO = 27.6, |
| | | average functionality = 2.2 |
| Mondur PF | Bayer | Urethane-modified isocyanate |
| | | prepolymer, % NCO = 23.0, |
| | | average functionality = 2.0 |

For each foam, all components except for the isocyanate were mixed and placed in a holding tank with agitation and under dry nitrogen in the amounts shown in Tables 2 to 6 below. All parts are by weight unless otherwise indicated. This mixture was then pumped at a controlled flow rate to a high shear mixing head of the Oakes type. The isocyanate mixture, were also separately pumped into the mixing head at controlled flow rates and at the proper flow ratios relative to the polyols mixture flow rate. Flow meters were used to measure and adjust the flow rates of the various raw material streams. Dry air was introduced into the mix head using a gas flow rate controller to adjust the airflow rate to produce a material of the desired final density. After mixing and foaming in the high shear mixer, the materials were pumped through flexible hoses and out through rigid nozzles. The foam was then cast onto coated release paper that had been dried just prior to the point where the foam was introduced. This prevented any water that might have been in the paper from participating in the reaction. The release paper was 13 inches wide and was drawn through the machine at a controlled speed, in this case at 10 feet per minute (FPM). The paper and cast foam then passed under a knife over plate (KOP) coater. The KOP spread the foam and was used to control the thickness of the final product. Preparation of elastomers is known in the art. In general, the above procedure may be followed, wherein the components are degassed prior to mixing, and the frothing step is omitted.

The coated release paper then passed through a curing section consisting of heated platens kept at 250° F. to 375° F. by a series of thermocouples, controllers and heating elements. A series of upper platens were kept at 450° F. The cured product then passed through an air-cooling section, a series of drive rollers and was wound up on a take-up roll.

Compression set resistance was determined by measuring amount in percent by which a standard test piece of the foam fails to return to its original thickness after being subjected to a 50% compression for 22 hours at the specified temperature.

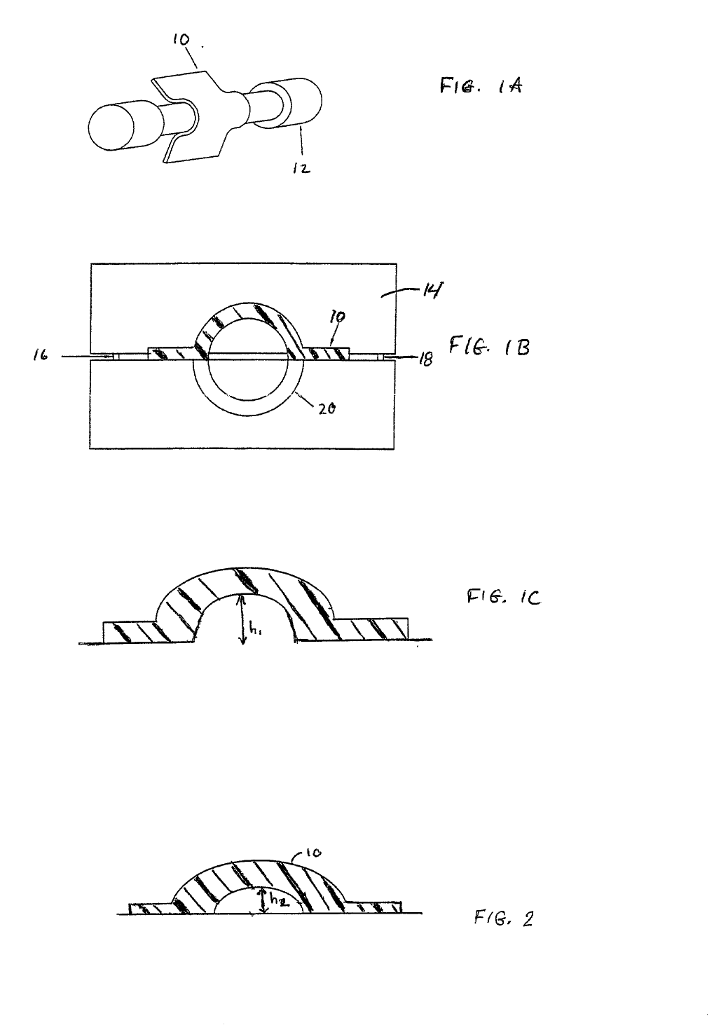

Tform factor was determined using the apparatus and method shown in FIGS. 1A to 1C. A straight strip of elastomer having no curvature 10 is first formed, and partially wrapped around a stainless steel rod 12 having a radius of 0.625 inches. Elastomer 10 and rod 12 are then placed in a two-part mold 14 having insert 20 in the bottom portion, along with shims 16, 18 such that when the mold is closed, the elastomer is compressed by a pre-determined amount. Mold 14 is then closed and heated for a fixed period of time, the mold is opened, and the strip of elastomer is removed. The strip is then held at room temperature for 30 minutes. The height of the highest portion of the curve (as shown in FIG. 1C) is then measured and designated h₁. The thermoforming factor or TForm factor is calculated as h₁ divided by 0.625.

To determine the recovery factor, the strip of elastomer thermoformed as in FIGS. 1A to 1B is placed on a flat table and a weight effective to provide a pressure of 15 pounds per square inch is placed on the entire elastomer for 24 hours under ambient conditions. The weight is removed, the sample is allowed to relax for 30 minutes, and the height at the highest portion of the curve is measured and designated h₂. The recovery factor is calculated as h₂ divided by 0.625. The recovery factor can also be calculated by placing the shaped strip into a 50° C. oven without any load for 24 hours or any specified period of time and then cooling to room temperature, followed by measuring height h₂ to evaluate the relaxation of the foam shape with heat.

The effect of varying isocyanate functionality is set forth in Table 2.

TABLE 2

| | Sample Number | | | | |
|---|---|---|---|---|---|
| Component | A | B | C | D | E |
| TONE 0201 | 15 | 15 | 15 | 15 | 15 |
| MPDiol | 0.8 | 0.8 | 0.8 | 0.8 | 0.8 |
| L-5617 | 3 | 3 | 3 | 3 | 3 |
| CATALYST | 6 | 6 | 6 | 6 | 6 |
| ALUMINA | 20 | 20 | 20 | 20 | 20 |
| 3A SIEVE | 2 | 2 | 2 | 2 | 2 |
| DPG | 10 | 10 | 10 | 10 | 10 |
| LG 56 | 43.23 | 43.23 | 43.23 | 43.23 | 43.23 |
| Mondur PF | 51.65 | 38.74 | 25.83 | 12.91 | 0 |
| BAYTUFT 751 | 0 | 12.91 | 25.83 | 38.74 | 51.65 |
| OH# | 155 | 155 | 155 | 155 | 155 |
| M_{c} | 15197 | 8887 | 6321 | 4924 | 4052 |
| FUNCTIONALITY | | | | | |
| Soft Segment | 2.09 | 2.09 | 2.09 | 2.09 | 2.09 |
| Hard Segment | 2 | 2.05 | 2.1 | 2.15 | 2.2 |
| Tform Factor | 0.96 | 0.5 | 0.53 | 0.47 | 0.06 |

As may be seen from the above data, it is apparent from columns A through E that the thermoformability is adversely affected when the isocyanate functionality increases significantly above 2.0. This shows that the isocyanate functionality should less than or equal to 2.15 and preferably less than or equal to 2.05 to yield good thermoformability. Compression set resistance of sample A was 3% at room temperature and 16% at 50° C.

Table 3 demonstrates the importance of soft segment crosslinking on the thermoformability and shape retention. The soft segment crosslinking is represented both by the soft segment functionality as well as the M_{c}, which is the molecular weight between crosslinks.

TABLE 3

| | Sample Number | | | | | | | |
|---|---|---|---|---|---|---|---|---|
| Component | F | G | H | I | J | K | L | M |
| L-5617 | 3 | 3 | 3 | 3 | 3 | 3 | 3 | 3 |
| ALUMINA | 20 | 20 | 20 | 20 | 20 | 20 | 20 | 20 |
| 3A SIEVE | 2 | 2 | 2 | 2 | 2 | 2 | 2 | 2 |
| CATALYST | 6 | 6 | 6 | 6 | 6 | 6 | 6 | 6 |
| IRGANOX 1135 | 0.12 | 0.12 | 0.12 | 0.12 | 0.12 | 0.12 | 0.12 | 0.12 |
| IRGANOX 5057 | 0.03 | 0.03 | 0.03 | 0.03 | 0.03 | 0.03 | 0.03 | 0.03 |
| TONE 0201 | 15 | 15 | 15 | 15 | 15 | 15 | 15 | 15 |
| MPDiol | 0.8 | 0.8 | 0.8 | 0.8 | 0.8 | 0.3 | 0.3 | 0 |
| DPG | 10 | 10 | 10 | 10 | 10 | 10 | 9 | 4.5 |
| PPG 2025/2000 | 20.05 | 10.5 | 0 | 0 | 0 | 17.37 | 17.37 | 22.17 |
| LG 56 | 23 | 32.55 | 43.23 | 45.9 | 60 | 12 | 0 | 0 |
| LHT 112 | 0 | 0 | 0 | 0 | 0 | 18 | 30 | 0 |
| LHT 240 | 0 | 0 | 0 | 0 | 0 | 0 | 0 | 30 |
| Mondur PF | 51.53 | 51.57 | 51.65 | 50.65 | 46.87 | 52.02 | 51.43 | 51.32 |
| RATIO | 1.02 | 1.02 | 1.02 | 1.02 | 1.02 | 1.02 | 1.02 | 1.02 |
| OH# | 155 | 158 | 158 | 155 | 158 | 158 | 158 | 157 |
| Mc | 35175 | 21682 | 15197 | 14120 | 11763 | 11603 | 8495 | 3723 |
| FUNCTIONALITY | | | | | | | | |
| Soft Segment | 2.041 | 2.065 | 2.093 | 2.100 | 2.13 | 2.140 | 2.196 | 2.339 |
| Hard Segment | 2 | 2 | 2 | 2 | 2 | 2 | 2 | 2 |
| Tform Factor | 0.9 | 0.7 | 0.8 | 0.8 | 0.9 | 0.4 | 0 | 0 |
| Recovery Factor | 0.2 | 0.1 | 0.7 | 0.6 | 0.4 | 0.0 | 0.2 | 0 |

All of the samples measured had good compression set resistance (<5%) measured at room temperature. As seen from columns F through M in Table 3, for these formulations, an M_{c} greater than or equal to 11600 or a soft segment functionality of less than or equal to 2.14 yields high thermoformability (TF Factor>0.7), which implies that a high level of soft segment crosslinking inhibits thermoformability. Even more surprising is that the recovery factor, which determines the shape retention of thermoformed material, is improved with soft segment functionalities greater than or equal to 2.065 (M_{c}<21,700). These functionalities are specific to the choice of raw materials used here. Different raw materials may result in a shift in the optimal functionality. In general, this discovery implies that the thermoformability and shape retention can be controlled in any formulation through an optimum balance of soft and hard segment crosslinking.

TABLE 4

| | Sample number | | |
|---|---|---|---|
| COMPONENT | N | O | P |
| L-5617 | 3 | 3 | 3 |
| ALUMINA | 20 | 20 | 20 |
| 3A SIEVE | 2 | 2 | 2 |
| CATALYST | 6 | 6 | 6 |
| IRGANOX 1135 | 0.12 | 0.12 | 0.12 |
| IRGANOX 5057 | 0.03 | 0.03 | 0.03 |
| TONE 0201 | 0 | 15 | 0 |
| STEPANPOL PS 2402 | 0 | 0 | 15 |
| PPG 425 | 15 | 0 | 0 |
| MPDiol | 0.8 | 0.8 | 0.8 |
| DPG | 10 | 10 | 10 |
| LG 56 | 43.23 | 43.23 | 43.23 |
| Mondur PF | 53.40 | 51.65 | 53.40 |
| RATIO | 1.02 | 1.02 | 1.02 |
| OH# | 160 | 155 | 160 |
| Mc | 15475 | 15299 | 15475 |
| Tform Factor | 0.1 | 0.8 | 0.7 |
| Recovery Factor | 0 | 0.6 | 0.5 |
| 25° C. C-set (%) | 3 | 3 | 3 |
| 50° C. C-set (%) | 3 | 16 | 10 |

Table 4 shows that polyester polyols or other phase separating polyols can contribute to attaining thermoformability (compare samples N and O). Sample P indicates that aromatic polyester polyol can also be used to make thermoformable foams and can result in better compression set resistance at elevated temperature.

Table 5 has examples that show various combinations of thermoformability, moisture management, and dual layer construction, wherein moisture management has been imparted through the addition of NaCMC.

TABLE 5

| | Sample No. | | | |
|---|---|---|---|---|
| | Q | R | S | T |
| Type of Foam | TF | TF-MM | TF-MM/R-MM | TF-MM/NR-MM |
| Single/Dual Layer | Single | Single | Dual | Dual |
| Resiliency | Res | Res | Res | Combined |
| Tform Factor | 0.8 | 0.8 | 0.7 | 0.7 |
| Recover Factor | 0.7 | 0.7 | 0.6 | 0.6 |
| Water Absorption | 15 | 257 | 257 | 300 |
| (%) | | | | |

TF = Thermoformable;
MM = Moisture Managing;
R = Resilient;
NR = Non-resilient

Samples Q and R are thermoformable and thermoformable with moisture management respectively. S and T represent dual layer versions of moisture managing thermoformable foams with moisture managing resilient and non-resilient foams respectively. It is to be understood that the moisture management system may be present in the thermo formable layer, another layer of the dual layer, or both the thermoformable and other layer. More than one layer (in addition to the thermoformable layer) may be present.

The effects of using various moisture management systems are shown in Table 6.

TABLE 6

| | Sample Number | | | |
|---|---|---|---|---|
| | U | V | W | X |
| Additive | NaCMC | Ca(CO₃) | PNVA | NaCMC/Ca(CO₃) |
| Parts in polyol mix | 11 | 20 | 20 | 20 |
| Compression set | <5% | <5% | <5% | <5% |
| resistance (%) | | | | |
| Water Absorption (%) | 341 | 73 | 135 | 205 |

Table 6 shows the use of NaCMC, poly(N-vinyl acrylamide) (PNVA), and calcium carbonate separately and in combination as moisture managing additives yield different levels of a water absorption of greater than or equal to 50% while retaining compression set resistance values at less than or equal to 5%.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A thermoformable polyurethane elastomer formed from a composition comprising:
an isocyanate-containing component having an average isocyanate functionality less than or equal to 2.15;
an active hydrogen-containing component having an average functionality less than or equal to 2.14; and
a catalyst.

2. The elastomer of claim 1, wherein the active hydrogen-containing component has an average functionality greater than or equal to or equal to 2.065.

3. The elastomer of claim 1, having a thermoformability factor greater than or equal to 0.5.

4. The elastomer of claim 1, having a recovery factor greater than or equal to 0.4.

5. The elastomer of claim 1, having a room temperature compression set resistance of less than or equal to 10% after 50% compression for 22 hours.

6. The elastomer of claim 1, having a 50° C. compression set resistance of less than or equal to 30% after 50% compression for 22 hours.

7. The elastomer of claim 1, having a thermoformability factor greater than or equal to 0.6, a recovery factor greater than or equal to 0.5, and a room temperature compression set resistance of less than or equal to 10% after 50% compression for 22 hours.

8. The elastomer of claim 1, having a thermoformability factor greater than or equal to 0.6, a recovery factor greater than or equal to 0.5, a room temperature compression set resistance less than or equal to 10%, and a 50° C. compression set resistance of less than or equal to 30% after compression to 50% for 22 hours.

9. The composition of claim 1, wherein the active hydrogen-containing component comprises a polyol.

10. The composition of claim 9, wherein the polyol is a mixture of a polyether polyol and a polyester polyol.

11. The composition of claim 9, wherein the polyester polyol is selected from the group consisting of aromatic polyesters and caprolactone-based polyesters.

12. The composition of claim 9, wherein the polyether polyol is selected from a group consisting of polypropylene ether based polyether triol.

13. The composition of claim 9, wherein the polyether polyol is selected from a group consisting of a mixture of polypropylene ether based polyether triol and diol.

14. The composition of claim 13, further comprising a moisture management system.

15. The composition of claim 1, wherein the average functionality of the isocyanate-containing component is 1.80 to 2.10.

16. The composition of claim 1, wherein the average functionality of the isocyanate-containing component is 2.00 to 2.05.

17. The composition of claim 1, wherein the average functionality of the isocyanate-containing component is 2.00.

18. The composition of claim 1, further comprising a moisture management system.

19. The composition of claim 18, wherein the moisture management system is selected from the group of additives consisting of sodium carboxymethylcellulose, poly(N-vinyl acrylamide), sodium acrylate, potassium acrylate, wood powder, corn starch, calcium carbonate, and mixtures comprising one of the foregoing additives.

20. The composition of claim 19, wherein the moisture management system is selected from the group of additives consisting of sodium carboxymethylcellulose, poly(N-vinyl acrylamide), calcium carbonate, and mixtures comprising one of the foregoing additives.

21. A multi-layer polyurethane elastomer composite comprising:
a layer of a thermoformable polyurethane elastomer; and
a layer of a polyurethane elastomer different from the thermoformable elastomer,
wherein the different polyurethane elastomer is disposed on and in intimate contact with the thermoformable polyurethane elastomer.

22. The composite of claim 21, wherein the layers are integrally bonded by wet-on-wet or wet-on-dry casting.

23. The composite of claim 21, wherein the thermoformable polyurethane elastomer layer, the different polyurethane elastomer layer, or both, comprise a moisture management system.

24. The composite of claim 23, wherein the moisture management system is selected from the group of additives consisting of sodium carboxymethylcellulose, poly(N-vinyl acrylamide), sodium acrylate, potassium acrylate, wood powder, corn starch, calcium carbonate, and mixtures comprising one of the foregoing additives.

25. The composition of claim 24, wherein the moisture management system is selected from the group of additives consisting of sodium carboxymethylcellulose, poly(N-vinyl acrylamide), calcium carbonate, and mixtures comprising one of the foregoing additives.

26. A composite polyurethane comprising a layer of a thermoformable polyurethane elastomer formed from a composition comprising:
an isocyanate component having an isocyanate functionality of 2.00 to 2.05;
an active hydrogen-containing component having an average hydrogen functionality of less than or equal to 2.14; and
a catalyst,
wherein the layer of thermoformable polyurethane elastomer is adhered or laminated to a non-thermoformable material.

27. The composite of claim 26, wherein the active hydrogen-containing component has an average hydrogen functionality of greater than or equal to 2.065.

28. The composite of claim 26, wherein the non-thermoformable material is a polyurethane elastomer.

29. The composite of claim 26, wherein the thermoformable polyurethane elastomer layer comprises a moisture management system.

30. The composite of claim 26, wherein the moisture management system is selected from the group of additives consisting of sodium carboxymethylcellulose, poly(N-vinyl acrylamide), sodium acrylate, potassium acrylate, wood powder, corn starch, calcium carbonate, and mixtures comprising one of the foregoing additives.

31. The composite of claim 30, wherein the moisture management system is selected from the group consisting of sodium carboxymethylcellulose, poly(N-vinyl acrylamide), calcium carbonate, and mixtures comprising one of the foregoing moisture management systems.

32. A shoe insert comprising the elastomer of claim 1.

33. A shoe insert comprising the elastomer of claim 21.

34. A shoe insert comprising the elastomer of claim 26.
